(19) United States
(12) Patent Application Publication
(10) Pub. No.: US 2002/0059184 A1
(43) Pub. Date: May 16, 2002

(54) Subject-oriented communication through the internet

(76) Inventors: Yoav Ilan, Givatayim (IL); Oren Gampel, Ramat Hasharon (IL); Uri Kareev, Ramat Hasharon (IL); Ori Berger, Ramat Hasharon (IL); Noam Rimon, Ramat Hasharon (IL); Gigi Sayfan, Kfar Saba (IL); Yair Halevi, Tel Aviv (IL)

Correspondence Address: DR. MARK FRIEDMAN LTD., C/O Bill Polkinghorn, 9003 Florin Way, Opper Marlboro, MD, 20772, US

(21) Appl. No.: 09/972,864

(22) Filed: Oct. 10, 2001

Related U.S. Application Data
(63) Continuation of application No. 09/320,573, filed on May 27, 1999, now abandoned.

(51) Int. Cl. G06F 7/00

(52) U.S. Cl. 707/1

(57) ABSTRACT

A system and method for providing real-time, subject oriented communication between two or More users Specifically, the present invention enables two or more users sharing an interest in the same subject area to become aware of each other, and therefore to communicate with each other in real time as a result. Such communication is initiated when each user interacts with a client to provide a string of characters to a central server, which then compares these strings of characters according to a comparison process. If the strings of characters are comparable according to this process, then the central server notifies each client thereby enabling the two clients to communicate.

### FIELD AND BACKGROUND OF THE INVENTION

The present invention relates to a system and method for establishing and maintaining real time, subject oriented communication between at least two users and, more particularly, to a system including a plurality of user clients and at least one server in which a plurality of users are brought into direct, real time and user dependent, communication with each other upon receipt of a specific string of characters, which cm be, for example, a URL (Uniform Resource Locator).

Real-time communication through a “chat channel” has been available over the Internet for many years. For example, the UNIX operating system permits primitive text-based, real-time communication between users. Real-time communication over the Internet through “chat channels” is also possible through user interfaces which are powerful and relatively easy to operate. For example, interactive, text-based real time communication is also possible through Internet Relay Chat (IRC). The Internet Relay Chat is a real-time, Internet-wide, multi-patty, text-based interaction tool. It allows users to interact in real-time about a subject of their choice, and to join and leave virtual “channels” devoted to specific topics.

Typically, real time interaction through a chat channel is initiated when two or more users access the same chat channel, which can be a predefined channel or a channel created and defined by one of the users. Upon access, communication can be established between the users and is dependent on their co-presence at the site. However, the co-presence is not data-related, or created in conjunction with retrieval of a data object.

An example of a system which provides communication in conjunction with the retrieval and access of a data object, such as a Web page, is described in U.S. Pat. Nos. 5,864,874 and 5,819,084. In these systems, the retrieval of a data object initiates a co-presence mechanism with which two or more users, who retrieve and access the same data object at the same time, can become aware of each other and consequently can communicate with each other in real time. The data retrieval system enables a user who retrieves and accesses a certain data object, such as a document, to discuss this document in real-time, with other users who might happen to access the document at the same time.

Although such systems provide users with a means to establish communication with other users with which they share common interests, and. further to be co-present and thus view and/or manipulate the same data object, such a co-presence mechanism is of limited application. For communication to be established and maintained, the data object must be viewed and as such maintained by the user client. Thus, either an inability to retrieve or to access the data object, or a loss of communication between the client and the data object, consequently leads to loss of communication between Represent users.

There is thus a widely recognized need for, and it would be highly advantageous to have, a system and method for establishing and maintaining real time, subject oriented communication between at least two users Such a system and method would allow users which share similar interests to communicate with each other upon input from a user operated client of a string of characters, which can be a URL for example.

### SUMMARY OF THE INVENTION

The present invention is of a system and method for providing real-time, subject oriented communication between two or more users. Specifically, the present invention enables two or more users sharing an interest in the same subject area to become aware of each other, and therefore to communicate with each other in real time as a result. Such communication is initiated when each user interacts with a client to provide a data string to a central server. Preferably, the data string is a string of characters. The central server then compares these data strings according to a comparison process. If the data strings are comparable according to this process, then the central server notifies each client, thereby enabling the two clients to communicate. Optionally and preferably, the two clients communicate through a separate communication server, although such a communication server could also be an integral part of the central server.

The data string optionally and preferably represents a data object such that the data string is a pointer to the data object. For example, the data string could be a string of characters which is an URL, pointing to a Web page. However, the system and method of the present invention does not require retrieval and access of the data object, and does not even require that the data object exists and is available for such retrieval and access. Rather, the data string could be a keyword, or a collection of keywords, corresponding to a particular subject area of interest to the user. For example, a user who wishes to correspond with other users on the subject of cars could enter the word “automobile” to the client of the present invention, or alternatively to an associated interface such as a Web browser. Even though no data object is necessarily retrieved or accessed, the data string “automobile” can be used to initiate communication with another user who is also interested in this subject area.

Preferably, the data string could be entered either directly or indirectly to the client of the present invention. For example, the data string could be entered directly through the GUI display of the client, or the data string could be entered into a Web browser which is in passive or active communication with the client. The client could then obtain the data string from the Web browser, for example through an API (Application Programming Interface) such as COM, or other APIs defined by the application.

According to the present invention there is provided a system for providing communication between a plurality of users, the plurality of users including at least a first user and a second user, the system comprising: (a) a plurality of user clients, each of the plurality of user clients being operated by a user, including at least a first user client being operable by the first user and a second user client for being operated by the second user; (b) at least one server connected to each of the plurality of user clients, the at least one server receiving at least one data string representative of a data object from at least the first user client and the second user client, such that upon receipt of the at least one data string the at least one server initiates communication between the first user client and the second user client; and (c) at least one communication server, connected to the at least one server, the at least one communication server providing a communication channel at least between the first user client and the second user client after receiving the request to initiate communication from the at least one server.

According to another embodiment of the present invention, there is provided a method for enabling and maintaining communication between a plurality of users, including at least a first user and at least a second user, the method comprising the steps of, (a) providing a plurality of user clients, each of the plurality of user clients being operated by a user, including at least a first user client for being operated by the first user and a second user client for being operated by the second user; (b) receiving a first data string representative of a first data object from the first user client; (c) receiving a second data string representative of a second data object from the second user client; (d) comparing the first data string and the second data string according to a comparison process; (e) if the first data string and the second data string are comparable, initiating communication between the first user client and the second user client; and (f) communicating between the first user client and the second user client through the communication channel.

Hereinafter, the term “client” refers to a user operated software functional module, which is preferably a software program which is installed and operated in a user operated computer. However, as detailed below, this functional module could also be implemented as firmware or hardware, or a combination thereof.

Hereinafter, the term “Web browser” refers to any software program which can display text, graphics, video, sound or other multimedia information, other information, or a combination thereof, from Web pages on World Wide Web sites. The Web browser is preferably able to operate a program written in the Java or JavaScript programming languages. Hereinafter, the term “Web page” refers to any document written in a mark-up language including, but not limited to, HTML (hypertext mark-up language) or AL (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Hereinafter, the term “Web site” refers to at least one Web page, and preferably a plurality of Web pages, virtually connected to form a coherent group. Hereinafter, the term “Web server” refers to a computer or other electronic device which is capable of serving at least one Web page to a Web browser.

Hereinafter, the term “applet” refers to a self-contained software module written in an applet language such as Java or constructed as an ActiveX™ control. Hereinafter, the term “computer” indicates any type of electronic device which is capable of performing computations, including, but not limited to, personal computers (PC) having an operating system such as DOS, Windows™, OS/2™ or Linux; Macintosh™ computers; computers having JAVAT™-OS as the operating system; thin client computers; “Web TV” electronic devices which combine a television set with at least a partial set of computational functions, preferably including the display of Web pages; and graphical workstations such as the computers of Sun Microsystems™ and Silicon Graphics™, and other computers having some version of the UNIX operating system such as AIX™ or SOLARIS™ of Sun Microsysteins™; a PalmPilot™, a PilotPC™, or any other handheld device or embedded system or device; or any other known and available operating system. Hereinafter, the term “Windows™” includes but is not limited to Windows95™, Windows 3.x™ in which “x” is an integer such as “1”, Windows NT™, Windows98™, Windows CE™ and any upgraded versions of these operating systems by Microsoft Inc. (USA),

Hereinafter, the phrase “display a Web page” includes all actions necessary to render at least a portion of the information on the Web page available to the computer user. As such, the phrase includes, but is not limited to, the static visual display of static graphical information, the audible production of audio information, the animated visual display of animation and the visual display of video stream data.

Hereinafter, the terms “computer user” and “user” both refer to the person who operates the Web browser or other GUI interface and navigates through the system of the present invention by operating a computer.

The method of the present invention could also be described as a plurality of instructions being performed by a data processor, such that the method of the present invention could be implemented as hardware, software, firmware or a combination thereof. For the present invention, a software application could be written in substantially any suitable programing language, which could easily be selected by one of ordinary skill in the art. The programming language chosen should be compatible with the computer and associated operating system by which the software application is executed. Examples of suitable programming languages include, but are not limited to, C, C++ and Java.

### BRIEF DESCRIPTION OF THE DRAWINGS

The invention is herein described, by way of example only, with reference to the accompanying drawings, wherein:

FIG. 1 is a schematic block diagram of a first exemplary embodiment of a system according to the present invention;

FIG. 2 is a schematic block diagram of a second exemplary embodiment of a system according to the present invention; and

FIG. 3 is a schematic block diagram of a third exemplary embodiment of a system according to the present invention.

### DESCRIPTION OF THE PREFERRED EMBODIMENTS

The present invention is of a system and method for providing real-time, subject oriented communication between two or more users. Specifically, the present invention enables two or more users sharing an interest in the same subject area to become aware of each other, and therefore to communicate with each other as a result. Such communication is initiated when each user' interacts with a client to provide a data string to a central server, which then compares these data strings according to a comparison process. If the data strings are comparable according to this process, then the central server notifies each client, thereby enabling the two clients to communicate. Optionally and preferably, the two clients communicate through a separate communication server, although such a communication server could also be an integral part of the central server.

The data string is preferably a string of characters. Optionally and more preferably, the data string represents a data object, such that the data string is a pointer to the data object. For example, the data string could be an URL which points to a Web page. However, the system and method of the present invention does not require retrieval and access of the data object, or even that the data object exists and is available for such retrieval and access. Rather, the data string could be a keyword, or a collection of keywords, corresponding to a particular subject area of interest to the user. For example, a user who wishes to correspond with other users on the subject of cars could enter the word “automobile” to the client of the present invention, or alternatively to an associated interface such as a Web browser. Even though no data object is necessarily retrieved or accessed, the data string “automobile” can be used to initiate communication with another user who is also interested in this subject area.

Preferably, the data string could be entered either directly or indirectly to the client of the present invention. For example, the data string could be entered directly through the GUI display of the client, or the data string could be entered into a Web browser which is in passive or active communication with the client. The client could then obtain the string of characters from the Web browser, for example through an API (Application Programming Interface) such as the API for COM objects, and so forth.

The principles and operation of a system and method for providing communication between a plurality of users according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

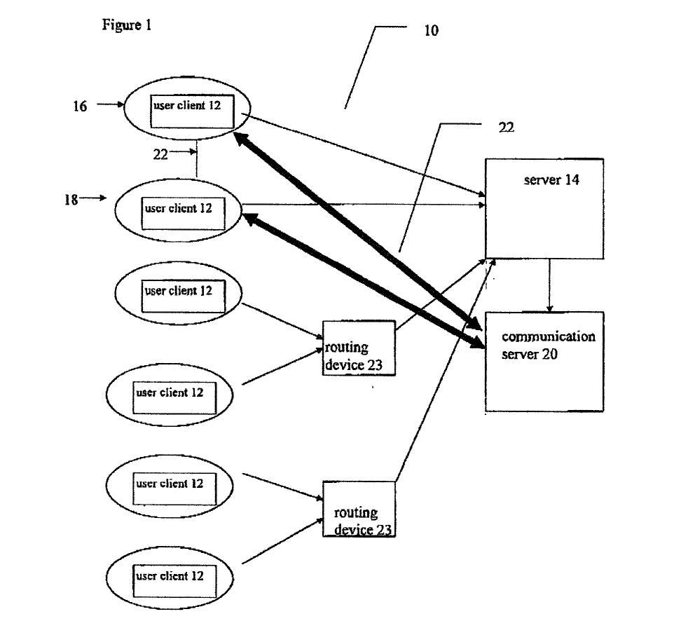

Referring now to the drawings, FIG. 1 illustrates a system 10 for providing real time, subject oriented communication between a plurality of users according to the present invention. System 10 includes a plurality of user clients 12, of which six are shown for the purposes of illustration only and without intending to be limiting in any way. Each user client 12 is operated from a user computer (not shown). System 10 further includes a comparison process server 14, which communicates with each of user clients 12 according to standard network protocols, preferably through TCP. Server 14 receives a data string, which is preferably representative of a data object, from any of user clients 12. As further detailed hereinunder, the data string is preferably a character string, which more preferably includes a specific sequence of alphanumeric characters and/or other characters. Optionally these alphanumeric characters are ASCII characters. Optionally and preferably, the alphanumeric character string is representative of a data object. Such a data object can include, but is not limited to, a Web page, a resource available through FTP (file transfer protocol), and information stored within a CD-ROM, such as, for example, a song title, or other data resources.

As further described hereinunder, upon receipt of an identical or similar data string from, for example, at least a first user client 16 and at least a second user client 18, server 14 issues a request to initiate communication between first user client 16 and second user client 18. The term “similar data string” refers to a data string which is considered to be similar according to a predefined comparison process For example, the comparison process could compare keywords related to the data strings, such that even if the received data strings themselves were not identical but the keywords related to each string were overlapping, the received data strings could be considered to be “similar”.

Server 14 issues the request to initiate communication to a communication server 20, lo which server 14 is also connected as shown. Communication server 20 provides a communication channel 22 between clients 12 for which communication was initiated by server 14, for example, first user client 16 and second user client 18. Communication channel 22 allows first user client 16 and second user client 18 to communicate in real-time. Preferably, once communication channel 22 is established, the communication between first user client 16 and second user client 18 is maintained by communication server 20 and is independent of server 14. As shown, communication channel 22 is indicated by arrows of a heavier thickness than those indicating communication between user clients 12 and server 14. A dashed line is shown between first user client 16 and second user client 18 to indicate that communication is occurring between these two user clients 12, and to indicate a second, optional embodiment of the present invention, in which first user client 16 and second user client 18 communicate directly without communication channel 22.

Thus, according to the present invention, to generate communication channel 22 between at least two users operating user clients 12 a first data string is provided from first user client 16 to server 14, and a second data string is provided from second user client 18 to server 14. Server 14 receives and analyses the two data strings, which for this embodiment are more preferably character strings, and compares them for the actual sequence content, and/or for the content of the data object they represent. As detailed hereinunder several processes can be utilized by the present invention for the comparison process.

For example, the following two character strings, “www.cnn.com/” and “www.abcnews.go.com/” each represent an address of a data object, which when displayed on a web browser provides a user with a web page display. Although these two web pages are accessed from two different addresses, represented by different character strings, the data objects (in this example, Web pages) which they represent provide similar viewing content, which is “news”. As such, when these two character strings are provided, for example, from two users of system 10 of the present invention, server 14 analyses and compares the content of these data objects, and/or compares keywords predefined for each of these data objects If these comparisons show that the data objects are similar, server 14 initiates communication between the two users as previously described hereinabove. Such analysis and comparison can be provided in reference to a library which includes cataloged addresses grouped and categorized in respect to content.

According to another embodiment of the present invention when a user is associated with a character string, following the input of that character string, this user can submit data to be associated with the character string such that this data is available to other users which are currently associated or will be associated with this character string. For example, a user associated with a web page which provides information on, for example, jazz, can submit information which is of relevance to other users accessing this Web page, this information which can be retrieved by the other users through client 16, can be provided as textual, audio and/or visual information.

Alternatively, once such a string of characters is relayed from a user to server 14, server 14 accesses the Web page represented by the string of characters and analyses it for content, by for example searching for repetitive keywords included within the web page. In this case, server 14 generates a keyword list for each of the two abovementioned web pages and determines similarly between these lists of keywords, for example, according to a predetermined similarity threshold. It will be appreciated by one ordinarily skilled in the art that methods for performing comparisons according to keywords are well known in the art. As such, software programs implemented with the system of the present invention are readily available and/or are easily programmable by one of ordinary skill in the art.

Another process, which can be implemented with system 10 for comparing two character strings, is optionally a sequence similarity process. For example, the following two character strings “www.cnn.com” and “www.cnn.con/sports” are not identical in sequence, but the first character string is identical to a portion of the second character sting. In other words, the two character strings share a sequence similarity, When two such character strings are submitted from, for example, first user client 16 and second user client 18, server 14 compares the two character strings for similarity starting preferably from the beginning of the character strings. In this case, a similarity threshold is predetermined, which is used to determine if a communication between the two user is initiated. Alternatively server 14 can sequentially delete characters from the longer character string submitted (www.cnn.com/sports), preferably from the end of the string. At the same time, server 14 preferably sequentially compares this character string, with at least one deleted character, to the other character string (wwwcnn.com).

Preferably, one or more characters from any given submitted character string are deleted if server 14 is not able to establish unawareness according to the character string without such deletion(s). For example, if submission of a character string by one user does not result in the establishment of co-awareness with at least one other user, deletion of one or more characters from such a character string is preferably performed so as to enable the establishment of co-awareness.

Following any of the above mentioned processes, if a similarity or identity is detected between these data strings, server 14 initiates communication between first user client 16 and second user client 18. Preferably initiation of communication includes causing each of first user client 16 and second user client 18 to become aware of the presence of the other by, for example, providing to both first user client 16 and second user client 18 information pertaining to the presence of another client. Preferably a user of client 12 can select a name or an icon through which co-awareness can be effected. As such, and unless otherwise desired, first user client 16 and second user client 18 are preferably only identified according to such a selected name or icon, and optionally otherwise remain anonymous. In addition, the awareness can also be defined by a user. In this case, when the above described process is used to establish co-awareness between any number of users, more preferably each user is able to filter the identity of other users for which co-awareness is established This feature of the present invention is particularly advantageous when co-awareness is instated between a large number of people, as is further described hereinbelow. In this case, a user can select to be aware, via, for example, filtering according to personal preferences, of only a fraction of the users. Such filtering information is preferably entered through client 12, while the actual process of filtration is optionally and preferably performed by server 14. In addition, and as further detailed below, when system 10 is first accessed by a user, server 14 generates and stores a user specific code to which information associated with a specific user of client 12 can be stored.

Once such co-awareness is instated, several alternative modes can be utilized so as to provide communication channel 22 between first user client 16 and second user client 18. For example, communication channel 22 can be provided from communication server 20 upon a command provided to server 14 from first user client 16 and/or second user client 18. In such a case, a command is relayed from first user client 16 and/or second user client 18 to communication server 14 to establish communication channel 22. Alternatively, once communication is initiated by either of first user client 16 and/or second user client 18, server 14 commands communication server 20 to automatically establish a communication channel 22 between first user client 16 and/or second user client 18. In this case, once co-awareness is established, first user client 16 and/or second user client 18 are provided with communication channel 22.

It will be appreciated that communication channel 22 optionally and preferably can provide real time bi-directional communication which can be textual, vocal and/or visual. Preferably communication and other relevant information such as, for example, the number of participants in such a communication session and the like is provided to the user via a graphic user interface of user client 12. Such interface can also provide other information which is not associated with a specific communication session as further described hereinunder.

According to another preferred embodiment of the present invention, communication can be established between user client 12 and other user clients 12 participating in an already active session. To this end, when a data string is received from user client 12 which is relevant in content to the already active communication session, user client 12 is added to the session and as such can communicate through dedicated communication channels with any of user clients 12 participating in such a session.

Accordingly, it will be appreciated that optionally any number of users can co-communicate through system 10 of the present invention. To provide communication to a large number of users simultaneously, system 10 of the present invention optionally and preferably employs a plurality of routing devices 23 (of which two are shown in FIG. 1 for the purposes of illustration only and without intending to be limiting). Such routing devices 23 can include software and/or hardware devices which are designed to enable system 10 of the present invention to handle a large number of communication channels and/or data streams, For example, each routing device 23 could include a computer which would act as a server computer, equipped with software to process each incoming request for communication from a user client 12.

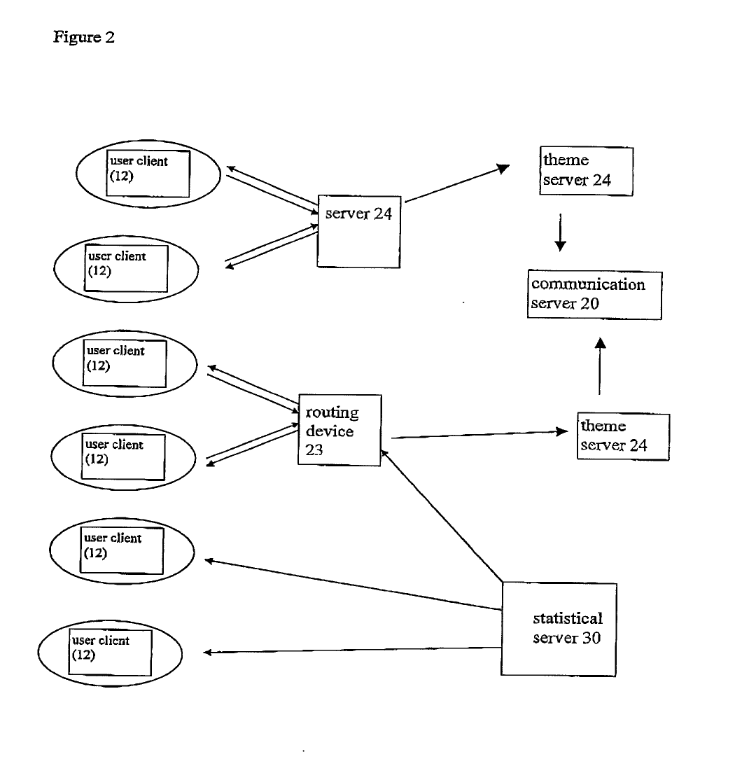

In addition to routing devices 23 and as seen in FIG. 2, system 10 optionally and preferably includes theme servers 24 which are implemented to provide routing according to themes. In this case, theme servers 24 can each be dedicated to a single theme or category and as such serve to stream communication from user clients 12 to server 14 according to a specific category. Such a category is preferably defined according to subject area, such that each theme server 24 would receive user input regarding a particular subject. For example any user clients 12 which relay a character string representing a data object including sports content would optionally and preferably be routed through a sports dedicated theme server 24. It will be appreciated, that although theme server 24 is described hereinabove as a routing server, it can also be configured to serve the function of server 14 and thus it can also be used to initiate communication between user clients 12.

As already mentioned hereinabove communication is initiated between user clients 12 upon relaying to server 14 a user input which includes a data string representing a data object. Alternatively and according to another preferred embodiment of the present invention, user client 12 can be configured to query software applications operating within the same computer platform for information regarding user preferences. For example, user client 12 can access and retrieve information relating to Web page addresses stored within a Web browser or other communication programs. Information relating to audio information played in a media player such as for example a music player, can also be accessed and retrieved.

Such information, when retrieved, can then be relayed as a string of characters or other data symbols to server 14 and processed in the same manner as above It will be appreciated by one ordinarily skilled in the art that such information and any other information relating to software modules and programs can easily be retrieved by accessing the application programming interface(s) (API) of such software. For example, if the data string is an URL for a Web page, which is entered through a Web browser being operated by the computer operating user client 12, then user client 12 can retrieve such a data string through the API for the particular Web browser software program. As such API information is made available to software developers, one of ordinary skill in the art could easily determine bow to access such information through the API. For example the dynamic data exchange protocol (DDE) used by the Netscape™ browser can be accessed, and information, such as the current URL to which the Web browser is pointing, can be retrieved and utilized by system 10.

According to another preferred embodiment of the present invention and as shown in FIG. 2, system 10 optionally and preferably includes a statistical server 30. Server 30 communicates with server 14 and stores statistical information corresponding to a plurality of data string inputs accumulated separately from each of user clients 12. This statistical information is preferably used to create a personal profile for each user interacting with user client 12. Server 30 then preferably uses such a personal profile to provide personalized data to user client 12. More preferably, such personalized data is provided through the graphic user interface of user client 12. Personalized data can include, for example, textual messages, images and sound files. Preferably, this profile is associated with the user assigned code already described hereinabove. In addition, the statistical data accumulated can be used to provide information relating to a specific data string. For example, information relating to a web page such as number of times accessed, number of times accessed by a specific user, and the average time period in which this web page is accessed, can be accumulated.

For example, a user interested in sports inay typically submit data strings representative of data objects which include sports oriented content. Thus, according to the present invention, statistical server 30 can deliver to a specific client 12, optionally via routing device 23, personalized data which suits the personal profile generated according to these submitted data strings. Such data can include, for example, scores accumulated daily from various sporting events, event schedules and the like.

Most preferably, such data could include personalized advertisements which are displayed through user client 12, such that the content of advertisements could be selected according to the data strings which had been submitted by the user.

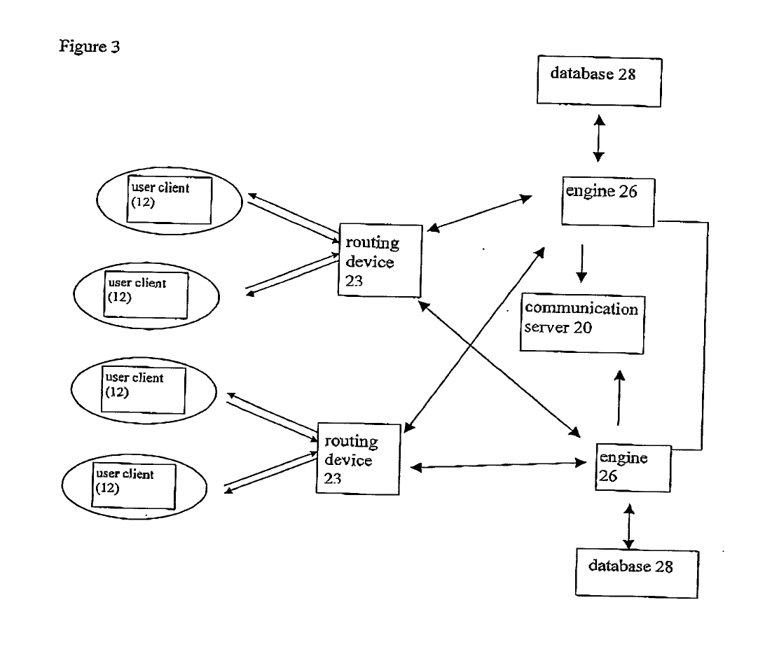

According to another embodiment of the present invention, shown in FIG. 3, the processing performed by routing device 23 optionally and preferably includes the steps of receiving the data string and sending the data string to an engine 26. Engine 26 is optionally and preferably implemented as a computer with software for processing the data string, which is in communication with routing device 23, for example through a network connection.

Engine 26 would receive at least a portion of such data strings, and preferably all of such data strings. If engine 26 receives all data strings, then engine 26 would perform the comparison process which was previously described for server 14. Engine 26 would preferably feature a database 28 for storing information related to such data strings, such as keywords for comparison and the like. If the comparison is positive, then engine 26 would notify communication server 20 and communication channel 22 would become operative as previously described.

Optionally and preferably, system 10 would feature a plurality of engines 26 as shown, in order to distribute the load across a number of different components of system 10. In this preferred embodiment, engines 26 would optionally be in communication with each other in order to sort the data strings, such that each engine 26 would only perform the comparison process on a portion of the data strings. The data strings would preferably be sorted according to some type of hashing function, for examnple according to the IP address of user client 12 or according to the content of the data string itself. More preferably hashing function would sort the data strings according to the content of the strings, such that each engine 26 might receive all strings only in a particular subject area, for example. Such sorting would have the advantage of only requiring each engine 26 to maintain a database of a selected portion of user clients 12 which are currently active, and would reduce the requirement for constantly updating database 28.

Alternatively and preferably, each engine 26 would have an identical copy of database 28, such that each engine 26 could perform all of the comparisons on the received data strings, but would still only receive a portion of the data strings. For this embodiment, database 28 is preferably constantly updated by communication between engines 26. More preferably, only alterations to database 28 are exchanged, thereby reducing the required bandwidth for communication. According to either embodiment, however, system 10 has a distributed architecture, which is highly preferred for maintaining high bandwidth without collisions or congestion.

Thus according to the present invention, system 10 provides a mechanism through which a user can establish real time communication with one or a plurality of users which share similar interests. Since such communication is provided by the system of the present invention in accordance with an input of a data string from the user clients, a retrieval of a data object such as a Web page is not required to initialize and/or to maintain such communication. Furthermore, since data strings submitted from several users do not have to be identical to in order to establish communication, and since these strings are not limited to the representation of Web associated data objects, a wide range of communication effectors is provided to a user of the present system.

In sharp contrast, to establish communication in background art systems such as the system described in U.S. Pat. Nos. 5,864,874 and 5,819,084, a retrieval of a specific and identical data object by the users co-communicating must be effected.

In addition, the present system can provide a user with valuable personalized data according to a profile generated for the user utilizing such a system. More preferably, such personalized data includes at least one advertisement for being shown through the user client GUI of the present invention.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for providing communication between a plurality of users, the plurality of users including at least a first user and a second user, the system comprising:
(a) at least one server connected to each of a plurality of user clients, said at least one server receiving at least one data string representative of a data object from at least a first user client and at least a second user client, such that upon receipt of said at least one data string said at least one server initiates communication between said first user client and said second user client; and
(b) at least one communication server connected to said at least one server, said at least one communication server providing a communication channel at least between said first user client and said second user client after receiving said request to initiate communication from said at least one server.

2. The system of claim 1, wherein said at least one server receives a first data string from said first user client and said at least one server receives a second data string from said second user client, such that said communication channel is provided between said fist user client and said second user client upon receipt of said first data string and said second data string.

3. The system of claim 1, wherein said data string is a string of alphanumeric characters.

4. The system of claim 3, wherein said sting of alphanumeric characters is selected from the group consisting of a URL, a DNS, an HTTP address, an FTP address and telnet address.

5. The system of claim 4, wherein said data object represented by said string of alphanumeric characters is a web page.

6. The system of claim 5, wherein each of said user clients is operated by a user computer, said system her comprising a user web client, such that said user web client is invokable to retrieve and display said web page from a web server upon relaying of said string of characters from one of said at least two user clients to said at least one server.

7. The system of claim 6, wherein the sequence of characters of said first string of characters corresponds to at least a portion of the sequence of characters of said second string of characters.

8. The system of claim 1, further comprising a data server communicating with said at least one server, said at least one data server being for storing statistical information corresponding to said relaying of a plurality of data strings by each of said at least two user clients, said statistical information serves for providing at least one data object to said each of said at least two user clients from said at least one third data server.

9. A method for enabling and maintaining communication between a plurality of users, including at least a first user and at least a second user, the method comprising the steps of:
(a) providing a plurality of user clients, each of said plurality of user clients being operated by a user, including at least a first user client for being operated by the first user and a second user client for being operated by the second user;
(b) receiving a first data string representative of a first data object from said first user client;
(c) receiving a second data string representative of a second data object from said second user client;
(d) comparing said first data sting and said second data string according to a comparison process;
(e) if said first data string and said second data string are comparable, initiating communication between said first user client and said second user client; and
(f) communicating between said first user client and said second user client through said communication channel.
